(19) United States
(12) Patent Application Publication
(10) Pub. No.: US 2012/0268583 A1
(43) Pub. Date: Oct. 25, 2012

(54) Active Microscope Filter and Lighting System

(76) Inventor: Howard Letovsky, Willits, CA (US)

(21) Appl. No.: 13/093,770

(22) Filed: Apr. 25, 2011

(51) Int. Cl. H04N 7/18

(52) U.S. Cl. 348/79; 348/E07.085

(57) ABSTRACT

The present invention discloses a unique and novel combination light source and active light filtering system for microscopes that eliminates the need for individual color filters, fluorescence filters, phase contrast filters, and many other filter types. The present invention provides almost unlimited light wavelength generation and filtering capabilities, as well as providing virtually unlimited dark field and phase contrast filter shapes, unique specimen lighting combinations, and all of the benefits of most commercially available light sources in a compact package that can be mounted on a microscope or used at a distance from a microscope, but be coupled to it through a fiber optic cable or other light transmission means. Additionally, the present invention eliminates the need for a filter wheel turret in a microscope's optical path, as well as eliminates the need for multiple fluorescent filter blocks in a fluorescent microscope optical path. The present invention can duplicate the functions of an almost infinite array of microscope filter systems to enable effective imaging of live cells without staining.

### FIELD OF THE INVENTION

The present invention relates to filters used to modify the wavelengths of light applied to specimens on transmitted, reflected, fluorescent, and all other types of microscopes. The present invention also relates to LCD, DLP, LED, Plasma, and other types of video projectors, as well as microprocessors.

### BRIEF DESCRIPTION OF PRIOR ART

Most high quality research grade microscopes use one or more separate filters to modify the light emitted from a light source directed at a specimen placed in the optical path of said microscope. These filters may be phase contrast, fluorescent, prism, band pass, dichroic, or simple colored gels used to block or allow the transmission of certain wavelengths of light. In all cases of prior art, the filters are passive devices. Further, said light sources aimed at said filters may be mercury vapor, halogen, LED, laser, or any other type of visible and invisible light sources.

Prior art discloses myriad types and styles of the aforementioned filters and light sources. However, in all cases of prior art, each filter is manufactured as a separate component intended to be inserted in a carrier in a microscope system and is designed to effect only one very specific wavelength—or a very narrow area of specific wavelengths—of light. Because of this limitation, a microscope can typically hold just a few filters in its optical path system. Often, these filters are provided in a rotating turret configuration. Also, each light source type has very specific and limited wavelength characteristics.

There is extensive prior art disclosing video projectors that use various types of translucent display panels driven by video generator hardware, a light source, and a lens to provide enlarged video images.

For many years, in a projector with a single DLP chip, colors were produced either by placing a color wheel between a white lamp and the DLP chip or by using individual light sources to produce the primary colors. In state of the art DLP and LED projectors, multi-color (RGB) LED and laser illuminated single-chip projectors are able to eliminate the spinning wheel.

A three-chip DLP projector has typically used a prism to split light from a single light source, and each primary color of light is then routed to its own DLP chip, then recombined and routed out through the combiner optical block. According to DLP.com, the three-chip projectors used in movie theaters can produce 35 trillion colors.

The main light source that has been used on DLP-based projectors is based on a replaceable high-pressure mercury-vapor metal halide arc lamp unit (containing a quartz arc tube, reflector, electrical connections, and sometimes a quartz/glass shield), while in some newer DLP projectors high-power RGB LEDs or lasers are used as a source of illumination.

Ordinary LED technology does not produce the intensity and high lumen output characteristics required to replace arc lamps. The patented LEDs used in all of the Samsung's DLP TVs, for example, are PhlatLight LEDs, designed and manufactured by US based Luminus Devices. A single RGB PhlatLight LED chipset illuminates these projection TVs. The PhlatLight LEDs are also used in a new class of ultra-compact DLP front projector commonly referred to as a “pocket projector” and have been introduced in new models from LG Electronics (HS101), Samsung electronics (SP-P400) and Casio (XJ-A series). Luminus Devices PhlatLight LEDs have also been used by Christie Digital in their DLP-based MicroTiles display system.

No DLP or LED projection system was ever intended to be interfaced to microscopes. However, the present invention takes advantage of the current state of the art in DLP and LED technology in a unique and novel system design to provide variable intensity, variable wavelength light source and active light filtering functions for microscopes.

### BRIEF SUMMARY OF THE INVENTION

The present invention discloses a unique and novel combination light source and light filtering system for microscopes that provides an active filter set of almost unlimited light wavelength generation and modification capabilities, as well as providing all of the benefits of most commercially available microscope light sources in a compact package that can be mounted on a microscope or used at a distance from a microscope yet be coupled to it through a fiber optic cable or other light transmission means. Additionally, the present invention can eliminate the need for a filter wheel turret in a microscope's optical path, as well as eliminate the need for multiple fluorescent filter blocks in a fluorescent microscope system.

In the preferred embodiment of the present invention components are combined from unrelated industries to improve the state of the art in microscopic specimen analysis. In the preferred embodiment, the video display element of a video projector, which may be a single translucent LCD, DLP, LED, Plasma, or equivalent translucent panel, capable of generating visible or invisible colors, shapes, or shades, and illuminated by one or more light sources is driven by a microprocessor. Using light sources that may include, halogen, mercury vapor, ultra bright RGB LED, and/or multi color laser systems, the video driver/microprocessor package incorporates a software component coded to output all colors, shapes, and shades available within the limits of said microprocessor and the display capabilities of said light sources and said translucent panel. A user interface and video display is provided to scroll through any or all of said available colors, shapes, or shades and “lock in” the color, shape, or shaded image of choice—thereby creating a customized filter. A condensing lens may also be used to collimate the light output from the invention in the optical path of a microscope.

Another embodiment of the present invention uses multiple translucent image generating panels, each panel illuminated by one or more available light sources. An optical block made up of multiple prisms and/or passive filters may be used to combine the output of said panels into a single image. This optical block/panel combination is driven by a substantially similar microprocessor controlling multiple video generator/driver packages described in the prior embodiment. Additionally, said panels may also be stacked without using said optical block to create other variations in filtration effects.

Another embodiment of the present invention, specifically intended for use in fluorescence microscopy, combines two sets of either of the aforementioned panel/video generator/light source embodiments, but configured in a typical fluorescent dichroic mirror housing, wherein one panel/video generator/light source set acts as the excitation filter which passes only the wavelength of light necessary for excitation from the excitation light source to a fluorophore. The dichroic mirror is the optical element that separates the excitation light from the fluorescence. A second panel/video generator/light source set acts as the barrier filter to separate fluorescence emanating from the fluorophore from other background light.

The foregoing embodiments, as well as other advantageous features of the embodiments, are explained in more detail with reference to drawings. Therefore, the same or similar reference numbers and components are used, as far as possible, to refer to the same or similar elements in all drawing figures.

### BRIEF DESCRIPTION OF THE DRAWINGS

FIG. 1 is a system flow chart of the present invention using one active panel.

FIG. 2 is a system flow chart of the present invention using multiple active panels.

FIG. 3 is a system flow chart of the present invention as a fluorescent filter block.

FIG. 4 is a system flow chart of the present invention in an alternate fluorescent filter block configuration.

FIG. 5 is a system flow chart of the present invention in a second alternate fluorescent filter block configuration.

FIG. 6 is a system flow chart of the present invention showing shape insertion.

### DETAILED DESCRIPTION OF THE INVENTION

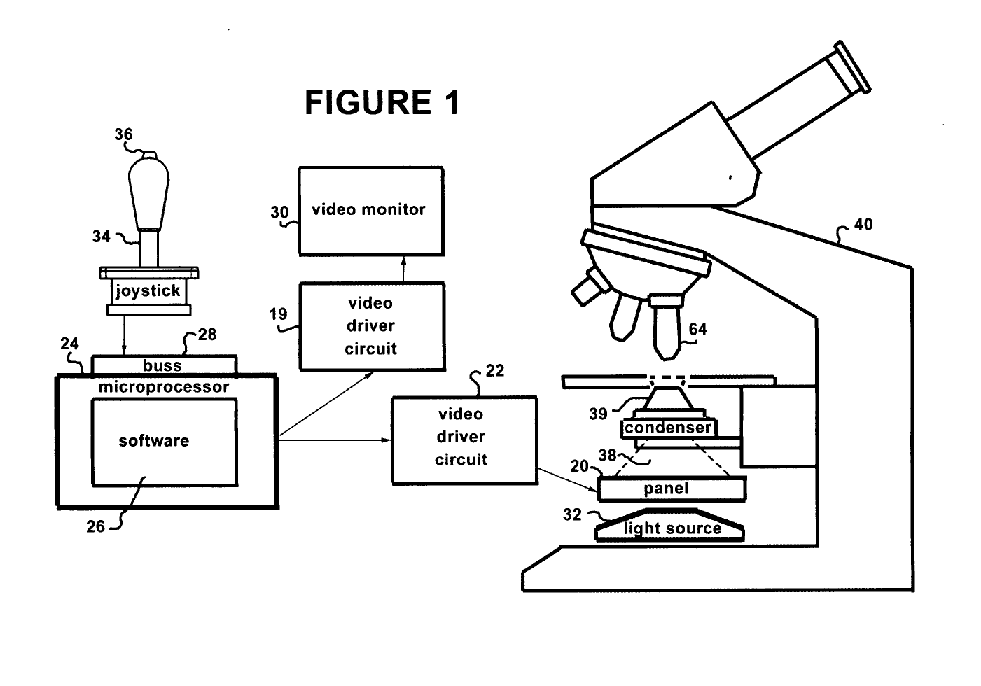

The preferred embodiment of the present invention as displayed in the system design flow chart in FIG. 1 incorporates an LCD, DLP, LED, Plasma, or any other translucent video image display panel 20 that may be capable of displaying a full range of shapes, visible or invisible colors and/or shades of grey, said panel 20 being electrically interfaced to a video driver circuit 22. Said circuit 22 is electrically connected to a microprocessor module 24. Software program 26 is incorporated into module 24, either as firmware, or as updateable software code through an external USB or equivalent buss 28. Program 26 is configured to provide a full range of shapes, visible or invisible colors, wavelengths of light, and shades of grey to said module 24 to control said circuit 22 to operate said panel 20 to output a display. Video monitor 30 may be a typical compact LCD or equivalent black and white or color display of the type that may be used in computer monitors, laptop computers, or cellular phones.

Monitor 30 is electrically interfaced to a video driver circuit 19, which is in turn controlled by module 24. Light source 32 may provide illumination for panel 20. Light source 32 may be Laser, multi-color laser, RGB LED, halogen, mercury vapor, front lighting, side lighting, or any other light source with output intensity and color functionality sufficient to satisfy the needs of a user of the system. User interface 34 can be a mouse, joystick, or any other x/y axis device which is interfaced to module 24 through buss 28 to enable selection of a shape, shade or color in circuit 22 with a software generated pointer, the code for which is integrated into program 26, said shape, shade or color being presented to a user on said display 30. User interface 34 incorporates at least one simple switch or button 36 to “lock in” said shade, shade or color selection in said program 26 for purposes of display on said panel 20 and said monitor 30. Circuits 19 and 22 may provide video signals that are different, or substantially identical on display 30 and panel 20.

Translucent video image display panels of the type used in laptop computers, computer monitors, and video projectors, as well as associated video driver circuits, microprocessors, color picker software programs, USB or equivalent busses, light sources, and user interfaces are all well known in prior art, so additional detail is not required herein. However, the present invention is a unique and novel integration of all of said discreet components, along with other unique features, the capability of integrating customizable software, and a unique system design, which improves the microscope state of the art.

Light path guide 38 can be an air space, mirrors, a simple hollow coupler, a fiber optic cable, or any other means capable of conducting the light output of source 32 toward an objective lens 64 in a viewing device 40. Light guide 38 may or may not incorporate a collimating lens 39. Device 40 in most cases will be a microscope, but can also be any other device which can benefit from the use of filtered light.

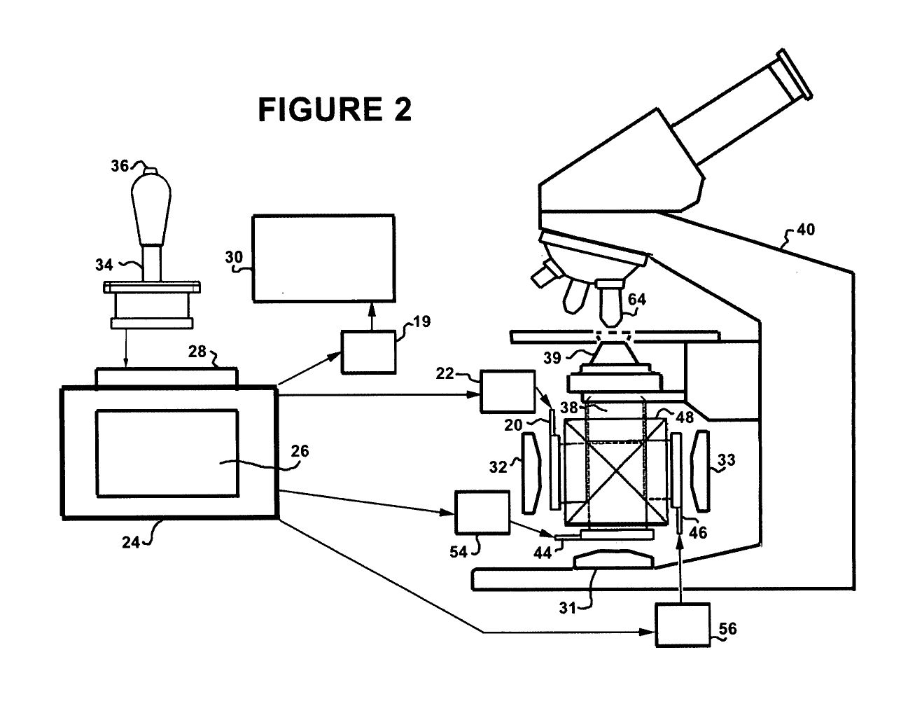

The preferred embodiment of the present invention as displayed in the system design flow chart in FIG. 2 incorporates a panel 20, but also incorporates additional equivalent video display panels 44 and 46 which are also capable of providing the same or different ranges of shapes, shades, colors, or wavelengths of light as panel 20. Said panels 20, 44, and 46 are mechanically interfaced to an optical combining prism block 48—well known in prior art—which is made up four prisms, and used to combine the output of multiple said panel 20, 44, and 46 into a single image. Panels 44 and 46 are driven by video driver circuits 54 and 56 respectively, said circuits being substantially identical to circuit 22. In this embodiment panel 20 is driven by circuit 22. Video driver circuits 22, 54, and 56 are all electrically interfaced to, and controlled by module 24 at the direction of software 26. Light sources 31 and 33 provide illumination for panels 44 and 46. The remainder of the FIG. 2 system may be substantially similar to that disclosed in FIG. 1.

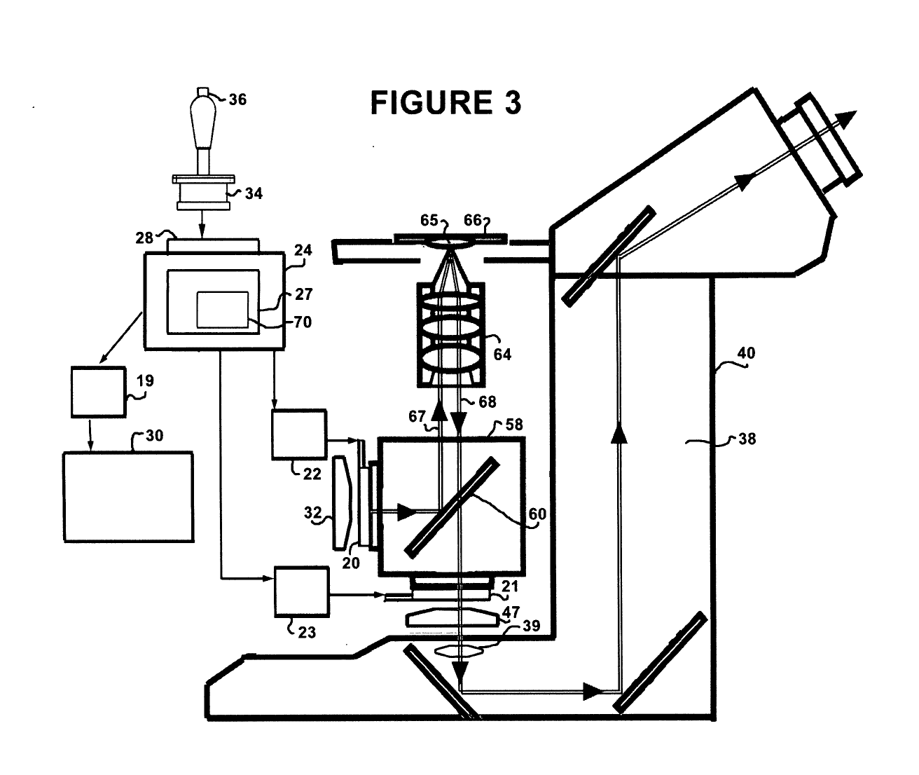

In the preferred embodiment of the present invention as displayed in FIG. 3, panel 20 is mounted on panel carrier 58. Another video display panel 21, substantially equivalent in function to panel 20, is also mounted to carrier 58 at an angle to said panel 20. Panel 21 may or may not need its own light source 47, but in many cases, the light transmitted by the excitation light sources 32, and in other embodiments, 31, and 33, will be enough. Dichroic mirror 60 is also mounted to carrier 58 at an angle such that light emitted by panel 20 can pass through dichroic mirror 60 and panel 21 to exit carrier 58 toward light guide 38, which can be a simple hollow coupler, mirrors, or a fiber optic cable, or any other means to direct the light output of source 32 toward a viewing device 40—which may be any kind of microscope or other device which can benefit from the present invention.

For ease of understanding and illustration, schematic microscopes are used in all Figures provided herein where a viewing device 40 is designated by number. Light guide 38 may or may not also incorporate a collimating lens 39.

In this FIG. 3 embodiment, an intended primary usage is in fluorescence microscopy, wherein excitation light signal 67 passing through carrier 58 may be directed by dichroic mirror 60 to pass through an objective lens 64 and strike a fluorophore 65 in a specimen 66, causing said fluorophore 65 to fluoresce and provide a return light signal 68 that travels back through objective lens 64 and on to ocular eyepiece 65 so as to be viewed by a user.

In this FIG. 3 embodiment, panel 20, controlled by circuit 22 at the direction of module 24, acts as an excitation filter which passes only the wavelength of light necessary for excitation light signal 67 from a light source 32 to a specific fluorophore 65. The dichroic mirror 60 is the optical element that separates the excitation light from the fluorescence return light signal 68. Panel 21 is electrically interfaced to a video driver circuit 23—essentially equivalent to circuit 22, which is also controlled by module 24. Panel 21 acts as the barrier filter to separate fluorescence emanating from the fluorophore 65 from other background light.

In this FIG. 3 embodiment, software program 27 incorporates all the capabilities of software program 26, but with the added functionality of using fluorescence filter lookup table 70 to automatically choose the shape, color or shade display of said panel 21 in response to user selection of the shape, color or shade display applied to said panel 20. Excitation and barrier filter combination lookup table 70 will incorporate substantially all known existing art data regarding excitation and barrier filter combinations so as to optimize this embodiment. Because of the flexibility of module 24 through buss 28, software program 27 may be updated at any time to incorporate and take advantage of new understandings of fluorescent light filter wavelength interactions.

The dichroic mirror 60 is the optical element that separates the excitation light 67 from light source 32 from the fluorescence return light 68. Dichroic mirrors are special mirrors that reflect only a specific wavelength of light and are well known in prior art. They allow all other wavelengths to pass through. Dichroic mirrors used in fluorescence microscope filter blocks are typically placed in a 45° incidence angle to light, creating a “stop band” of reflected light and a “pass band” of transmitted light. Light passing through said excitation filter may be reflected 90° toward an objective lens 64 and a specimen containing a fluorophore 65. Light emanating from a fluorophore 65 is then passed through and directed toward the optical output of a microscope 40. The lookup table software 70 may incorporate a virtually unlimited range of excitation/barrier filter combinations.

Barrier filters are optical elements that separate fluorescence emanating from a fluorophore 65 from other background light. A barrier filter panel 21 may transmit light of the fluorescence wavelength which passes through the dichroic mirror 60 while blocking all other light leaking from the excitation lamp light source 32—reflected from the specimen or optical elements. This is necessary because the strength of the fluorescent light from a fluorophore is weaker than the excitation light by a factor that can exceed 100,000:1. As shown in FIG. 3, the software program 27 includes fluorescent filter optimizing look-up tables 70 which may incorporate all variables currently known, and those that may be later discovered, that apply to excitation and barrier filter combinations.

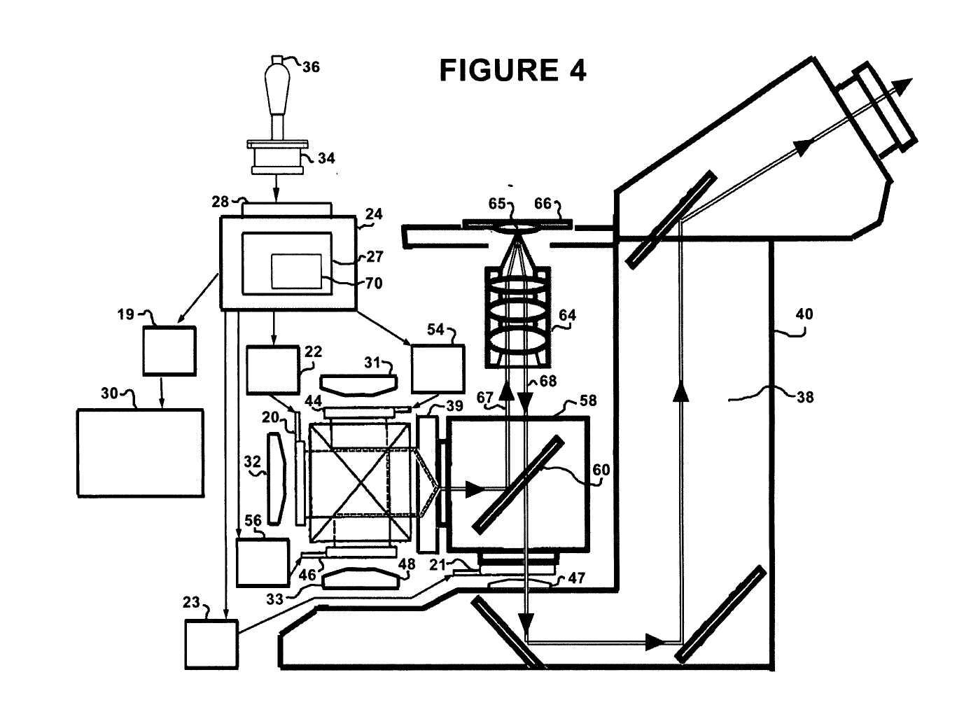

The preferred embodiment of the present invention as displayed in FIG. 4 incorporates translucent video image display panel 20, but also incorporates additional equivalent translucent LCD, DLP, or equivalent video display panels 44 and 46. Said panels 20, 44, and 46 are mechanically interfaced to an optical combining prism block 48. Panels 44 and 46 are driven by video driver circuits 54 and 56 respectively, said circuits being substantially identical to circuit 22. Panel 20 is driven by circuit 22. Video driver circuits 22, 54, and 56 are all electrically interfaced to, and controlled by module 24. Light sources 31 and 33 may provide illumination for panels 44 and 46. The remainder of the FIG. 2 system may be substantially similar to that disclosed in FIG. 1. Prism block 48 is mounted on carrier 58 in substantially the same manner as the single panel 20 is mounted to said carrier 58 in FIG. 3.

In the embodiment disclosed in FIG. 4, a translucent LCD, DLP, or equivalent video display panel 21 is also mounted to carrier 58 at an angle to said prism block 48 as in FIG. 3. Dichroic mirror 60 is also mounted to carrier 58 at an angle such that light emitted by panels 20, 44, and 46 can pass through said prism block 48 and on through dichroic mirror 60 and panel 21 to exit carrier 58 toward light guide 38, which can be a simple hollow coupler or a fiber optic cable, or any other means to direct the light output of light sources 32, 31, and 33 toward a viewing device 40. Light guide 38 may or may not incorporate a collimating lens 39. Device 40 may be a microscope or any other device which can use filtered light. Another tight source 47, substantially equivalent to light sources 31, 32, and 33 may also be incorporated to further illuminate panel 21.

In this FIG. 4 embodiment, an intended primary usage is in fluorescence microscopy, wherein light passing through light guide 38 may be directed to pass through an objective lens 64 and strike a fluorophore 65 in a specimen 66, causing said fluorophore 65 to fluoresce and provide a return light signal 68 that travels back through objective lens 64 and on to ocular eyepiece 65 so as to be viewed by a user.

In this FIG. 4 embodiment, panels 20, 44, and 46, controlled by circuits 22, 54, and 56 at the direction of module 24, act in concert as an excitation filter which passes only the wavelength of light necessary for excitation from light sources 32, 31, and 33 to the fluorophore 65. The dichroic mirror 60 is the optical element that separates the excitation light from the fluorescence return light 68. Panel 21 is electrically interfaced to a video driver circuit 23, which is in turn controlled by module 24. Panel 21 acts as the barrier filter to separate fluorescence emanating from the fluorophore 65 from other background light. In this embodiment, software program 27 incorporates all the capabilities of software program 26, but with the added functionality of using filter lookup table 70 to automatically choose the color or shade of said panel 21 in response to user selection of the color or shade applied to panels 20, 44, and 46. Excitation and barrier filter combination lookup table 70 will incorporate substantially all known existing art data regarding excitation and barrier filter combinations so as to optimize this embodiment. Because of the flexibility of module 24 through buss 28, software program 27 may be updated at any time to take advantage of new understandings of fluorescent light filter wavelength interactions.

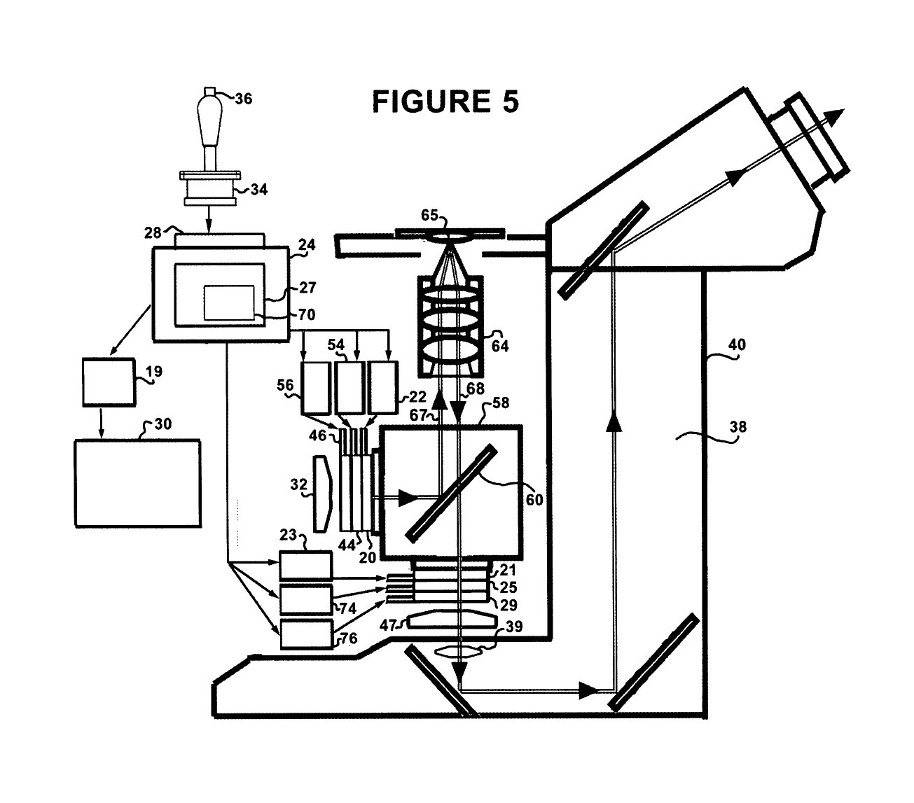

The preferred embodiment of the present invention as displayed in FIG. 5 incorporates a translucent video image display panel 20, but also incorporates additional panels 44 and 46. Said panels 20, 44, and 46 are mechanically interfaced, in a stack, to carrier 58.

Panels 44 and 46 are driven by video driver circuits 54 and 56 respectively, said circuits being substantially identical to circuit 22. Panel 20 is driven by circuit 22.

Video driver circuits 22, 54, and 56 are all electrically interfaced to, and controlled by module 24. Light source 32 may provide illumination for panels 22, 44 and 46. The remainder of the FIG. 2 system may be substantially similar to that disclosed in FIG. 3. Another translucent LCD, DLP panel 21, as well as additional translucent equivalent video image display panels 25 and 29, which are also substantially equal in function to panel 20, and are all mechanically interfaced, in a stack, to carrier 58 at an angle to panels 20, 44, and 46. Said panels 21, 25, and 29 may have their own independent light source 47, and their own driver circuits 23, 74, and 76, which are all electrically interfaced to, and controlled by module 24.

Dichroic mirror 60 is also mounted to carrier 58 at an angle such that light emitted by panels 20, 44, and 46 can pass through dichroic mirror 60 and panels 21, 25, and 29 to exit carrier 58 toward light guide 38, which can be a simple hollow coupler or a fiber optic cable, or any other means to direct the light output of source 32 toward a viewing device 40. Light guide 38 may or may not incorporate a collimating lens 39. Device 40 may be a microscope or any other device which can use filtered light.

In this FIG. 5 embodiment, panels 20, 44, and 46 act in concert as excitation filters, and panels 21, 25, and 29 act in concert as barrier filters. The remainder of the system is substantially similar to that disclosed in FIG. 3.

Software programs 26 and 27 incorporate “color picker” and shape generation software to output all light wavelengths, colors, shapes, and shades available within the limits of said module 24. Color picker and shape generation software is readily available. User interface 34 is provided to scroll through any or all of said available colors and use button 36 to “lock in” the color filter of choice.

It is important to include the capability of variable light output to the light sources 32, 31, 33, and 47. This is accomplished simply by controlling the voltage applied to the panels, and this capability is inherent both internally and remotely in virtually all currently available light sources. Said variable light output and can be effected by module 24 in all embodiments of the present invention through buss 28 if desired. It is important to note that it is also possible to use a single light source to illuminate all of the panels 20, 44, 46, 21, 25, and 29 using prior art mirrors, passive filters, and beam splitters. Therefore, this approach is not detailed in the present invention. However, it is hereby disclosed herein as a possible component of the present invention.

Since all panels 20, 44, 46, 21, 25, and 29, and their respective light sources, in the embodiments of the present invention as disclosed in FIGS. 1 through 6 are fully controllable by their respective video driver circuits 22, 54, 56, 72, 74, and 76, which are all electrically interfaced to, and controlled by module 24, and software packages 26 and 27, any portion of said panels 20, 44, 46, 21, 25, and 29 can also generate darkened shapes of any size in any zone of their full area. This capability can duplicate or simulate the functions of an almost infinite array of phase contrast filters, DIC filters, Zeiss Varel filters, and many other specific microscope filters to enable effective imaging of live cells without staining, and more effective imaging of microscopic specimens in general.

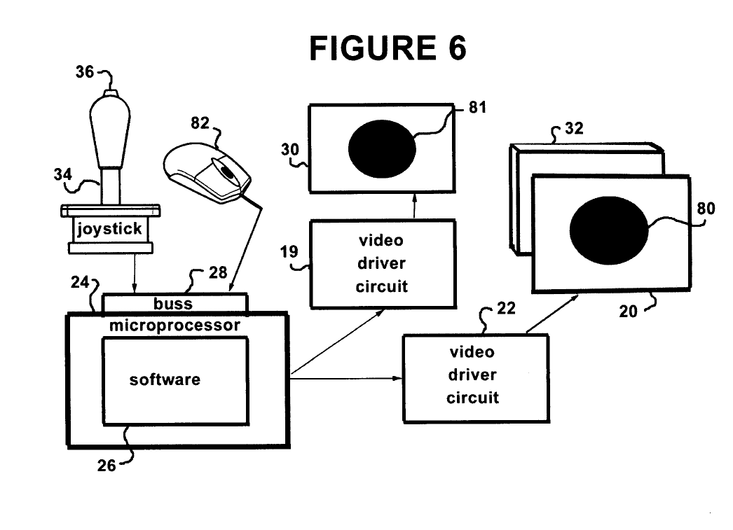

An aspect of this shape generation and shape insertion capability of the preferred embodiment of the present invention as disclosed in all FIGS. 1 through 5 is displayed in the system block diagram in FIG. 6. A translucent video image display panel 20 is electrically interfaced to a video driver circuit 22. Said circuit 22 is electrically connected to a microprocessor module 24. Software program 26 is incorporated into module 24, either as firmware, or as updateable software code through a USB or equivalent buss 28. Program 26 is configured to provide a full range of visible or invisible colors, wavelengths of light, shades of grey, and variations of shapes, to said module 24 to control said circuit 22 to operate said panel 20.

Video monitor 30 is electrically interfaced to a video driver circuit 19, which is in turn controlled by module 24. Light source 32 may provide illumination for panel 20. User interface 34 is interfaced to module 24 through buss 28 to enable selection of a shade, shape, or color in circuit 22 with a software generated pointer, the code for which is integrated into program 26, said shade, shape, and/or color being presented to a user on said display 30. User interface 34 incorporates at least one simple switch or button 36 to “lock in” a shade or color selection in said program 26. Circuits 19 and 22 may provide video signals that are different, or substantially identical on display 30 and panel 20.

In FIG. 6, a circular darkened shape 80 is displayed on panel 20 in substantially the center of the panel. This shape could be any geometric or amorphous shape generated as a function of the software 26 and 27. A second user interface 82 such as a keyboard, tablet, mouse, or any other device that can be interfaced to microprocessor 24 through buss 28 may be also used to create and/or assign said shape 80 to any panels 20, 44, 46, 21, 25, and 29 in any of the embodiments of the present invention as disclosed in FIGS. 1 through 6. Shape 81 may be substantially identical to shape 80 and is displayed on video monitor 30.

It is hereby noted that the disclosed embodiments of the present invention herein do not necessarily exhibit all of the advantages of the present invention.

What is claimed is:

1. An active light filtering system that incorporates in combination:
at least one light source;
at least one translucent video image display panel, capable of generating a range of shapes, wavelengths of light, visible or invisible colors, shades of said colors, or shades of grey, and said at least one translucent video image display panel being either self illuminated, or illuminated by said at least one light source;
at least one microprocessor;
at least one video generator circuit capable of being controlled by said at least one microprocessor;
said at least one microprocessor including at least one software component coded to output all shapes, wavelengths of light, colors and shades of grey available within the limits of said at least one video generator circuit and said at least one microprocessor combination;
at least one user interface coupled to said at least one microprocessor which includes at least one software component configured to allow a user to scroll through any or all of said available shapes, wavelengths of light, colors and shades of grey and “lock in” a shape, wavelength, color or shade of choice.

2. An active light filtering system according to claim 1 that incorporates at least one condensing lens.

3. An active light filtering system according to claim 1 that incorporates at least one microscope.

4. An active light filtering system according to claim 1 that incorporates at least three said translucent video imaging panels, and at least one optical block configured to combine the output of said at least three panels into a single image.

5. An active light filtering system according to claim 4 that incorporates at least one microscope.

6. An active light filtering system that incorporates in combination:
at least one light source;
at least one first translucent video image display panel, capable of generating a range of shapes, wavelengths of light, visible or invisible colors, shades of said colors, or shades of grey, and said at least one first translucent video image display panel being either self illuminated, or illuminated by said at least one light source, and configured to act as an excitation filter which produces only the wavelength of light necessary for excitation from said light source to a fluorophore;
at least one dichroic mirror;
at least one second translucent video image display panel, capable of generating a range of shapes, wavelengths of light, visible or invisible colors, shades of said colors, or shades of grey, and said at least one second translucent video image display panel being either self illuminated, or illuminated by said at least one light source, and configured to act as a barrier filter to separate said fluorescence emanating from said fluorophore from other background light.
at least one carrier configured to contain said at least one first translucent video image display panel, said at least one second translucent video image display panel, and said at least one dichroic mirror;
at least one microprocessor;
at least one video generator circuit capable of being controlled by said at least one microprocessor;
said at least one microprocessor including at least one software component coded to output all shapes, wavelengths of light, colors and shades of grey available within the limits of said at least one video generator circuit and said at least one microprocessor combination;
at least one user interface coupled to said at least one microprocessor which includes at least one software component configured to allow a user to scroll through any or all of said available shapes, wavelengths of light, colors and shades of grey and “lock in” a shape, wavelength, color or shade of choice.

7. An active light filtering system according to claim 6 that incorporates at least one condensing lens.

8. An active light filtering system according to claim 6 that incorporates at least one microscope.

9. An active light filtering system according to claim 6 that incorporates more than one of said at least one second translucent video image display panels in a stack to act as an excitation filter for light applied toward a fluorophore.

10. An active light filtering system according to claim 6 that incorporates more than one of said at least one second translucent video image display panels in a stack to act as a barrier filter to separate said fluorescence emanating from said fluorophore from other background light.

11. An active light filtering system according to claim 6 that incorporates at least three translucent video image display panels, and at least one optical block configured to combine the output of said at least three translucent video image display panels into a single image, so that said at least three translucent video image display panels and said at least one optical block to act as an excitation filter for light applied toward a fluorophore.

12. An active light filtering system according to claim 6 that emulates phase contrast filters.

13. An active light filtering system according to claim 6 that emulates dark field filters

14. An active light filtering system according to claim 6 that emulates Varel filters.

15. An active light filtering system according to claim 6 that emulates DIC filters.
